(19) United States
(12) Patent Application Publication
(10) Pub. No.: US 2003/0190187 A1
(43) Pub. Date: Oct. 9, 2003

(54) Clamp and method for using

(76) Inventor: Richard Lanka, Twinsburg, OH (US)

Correspondence Address: FAY, SHARPE, FAGAN, MINNICH & McKEE, LLP, Seventh Floor, 1100 Superior Avenue, Cleveland, OH, 44114-2518, US

(21) Appl. No.: 10/225,601

(22) Filed: Aug. 22, 2002

Related U.S. Application Data
(60) Provisional application No. 60/373,307, filed on Apr. 8, 2002.

(51) Int. Cl. F16B 2/18; F16B 7/04

(52) U.S. Cl. 403/374.3

(57) ABSTRACT

A clamp for securing multiple items is provided. The clamp includes a body and a securing means connected to the body. The securing means and the body cooperate to engage a first item. At least one selectively pivotable block is connected to the body and the block is connected to a second item to be clamped. A method for clamping is also provided.

### CROSS REFERENCE TO RELATED APPLICATION

This application claims the benefit of U.S. Provisional application Serial No. 60/373,307, filed on Apr. 8, 2002.

### FIELD OF THE INVENTION

The present invention relates to the art of clamps. More particularly, the present invention relates the art of clamps for shoring systems that are used to stabilize structures.

### BACKGROUND OF THE INVENTION

When a catastrophic event, accident or force of nature, such as an earthquake, tornado, hurricane, flood, fire, or snow load occurs, building structures are often weakened. Such weakened structures may suddenly shift or collapse, endangering rescue workers, inspectors or other people in the vicinity. In addition, a shift or collapse may affect other structures that are nearby, either by hitting and directly damaging them or by weakening a common or adjacent foundation.

As a result, it is often necessary to support a weakened structure, commonly termed “shoring,” quickly yet securely. In addition, shoring is a task that is often performed by rescue personnel, who may be engaged in multiple tasks simultaneously, such as extinguishing a fire, attending to victims and shoring a structure. Thus, a shoring system must be capable of being assembled quickly and easily.

The system must also be durable, as it must support the heavy load of a building structure for a fairly long period of time, often up to a few weeks or longer. Because the shoring system will be used to support a variety of structures, it must also be adjustable.

Critical to a shoring system is the means to secure the members of the system or of multiple systems together. In the prior art, shoring systems have included wood, which was often wedged or nailed together. However, wood systems lack adjustability and are not durable, often being discarded after one shoring use.

Some newly invented shoring systems involve the use of tubular metal members, which are more durable. These members may be pinned together. However, the use of pins or similar fasteners may often be restrictive, as the pins can only be inserted through pre-determined holes in the members.

It is therefore desirable to develop a strong, reusable and durable clamp that is also adjustable and easy to use.

### BRIEF SUMMARY OF THE INVENTION

In an exemplary embodiment of the present invention, a clamp for securing multiple items is provided. The clamp includes a body and a securing means connected to the body. The securing means and the body cooperate to engage a first item. At least one selectively pivotable block is connected to the body and the block is connected to a second item to be clamped.

In another exemplary embodiment of the present invention, a connecting system for a support member is provided. The connecting system includes a cross brace including a bracket and a clamp. The clamp includes a body and a securing means connected to the body. The securing means and the body cooperate to engage the support member. At least one selectively pivotable block is connected to the body and the block is connected to the bracket of the cross brace.

In yet another exemplary embodiment of the present invention, a method for clamping is provided. The method comprises the steps of providing a first item to be secured, placing a body of a clamp on a desired location of the first item to be secured, closing a securing member of the clamp about the item to be secured, tightening the securing member to the body of the clamp, providing a second item to be secured, selecting a desired orientation of a block connected to the body of the clamp, affixing the block to the body of the clamp at the desired location, and connecting the block to the second item to be secured.

There are other objects and features of the invention, which will be apparent from the following description and claims.

### BRIEF DESCRIPTION OF THE FIGURES

The following is a brief description of the drawings, which are presented for the purpose of illustrating the invention and not for the purpose of limiting the same, and wherein:

FIG. 1 is a perspective view of a shoring system;

FIG. 2 is a perspective view of another shoring system;

FIG. 3 is a side view of a component of the shoring systems of FIGS. 1 and 2;

FIG. 4 is a front view an embodiment of the present invention;

FIG. 5 is a side view along line F5-F5 of the embodiment of FIG. 4; and

FIG. 6 is a perspective view of an embodiment of the invention in use.

### DETAILED DESCRIPTION OF THE INVENTION

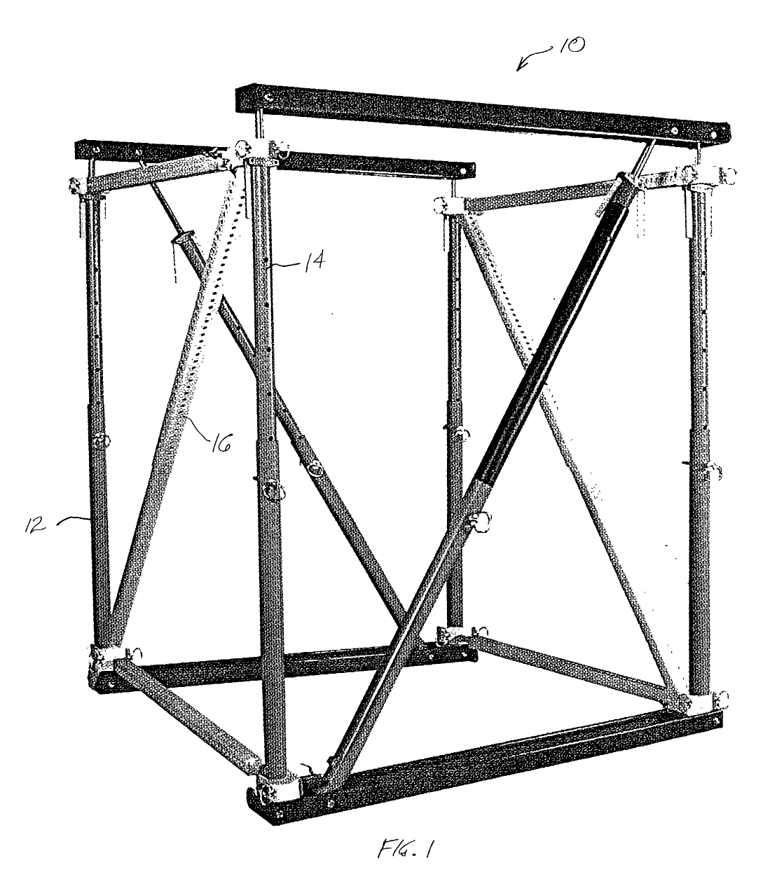

Referring now to the drawings, wherein the showings are for purposes of illustrating preferred embodiments of the invention and not for the purpose of particularly limiting the same, FIG. 1 illustrates a first shoring system 10 that is generally used to support a horizontal structure from below. Tubular support members 12 and adjusting members 14 provide the support for the shoring system 10. Extending between the support members 12 and adjusting members 14 are cross braces 16. The cross braces 16 facilitate the formation of a three-dimensional structure for the shoring system 10 to allow the system 10 to support a substantial area.

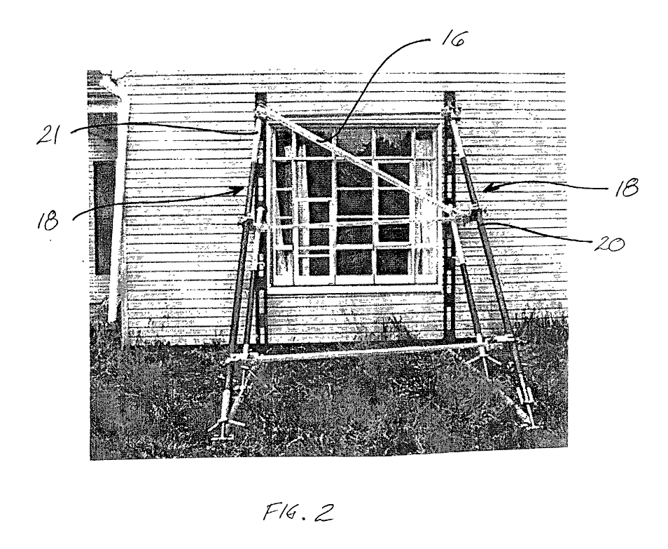

Turning now to FIG. 2, two second shoring systems 18 that support a vertical structure are illustrated. To secure the second systems 18 together so that they may be more stable, cross braces 16 extend between tubular extension members 20 and tubular adjusting members 21. The cross braces 16 shown in FIGS. 1 and 2 must be able to connect to the members 12, 14, 20 and 21 from many different angles and locations. As a result, adaptable securing means are necessary.

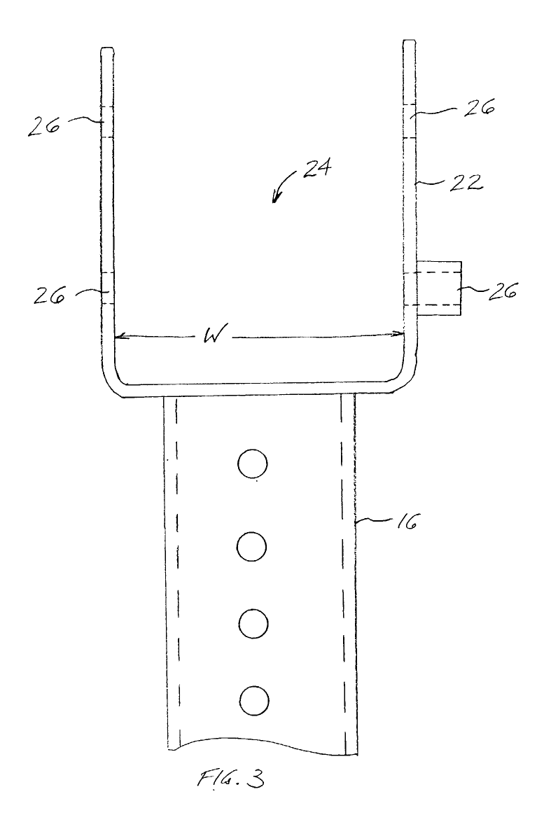

As shown in FIG. 3, a cross brace 16 may terminate in a bracket 22. The bracket 22 defines a channel 24 of a width W and orifices 26 that allow a pin or other fastener to secure an item to the cross brace 16.

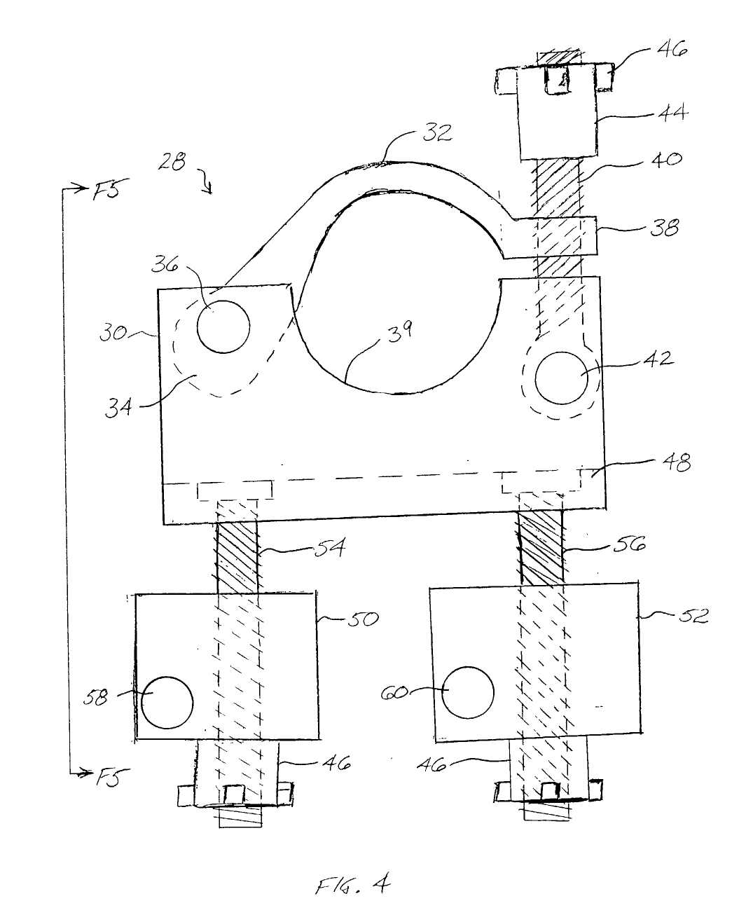

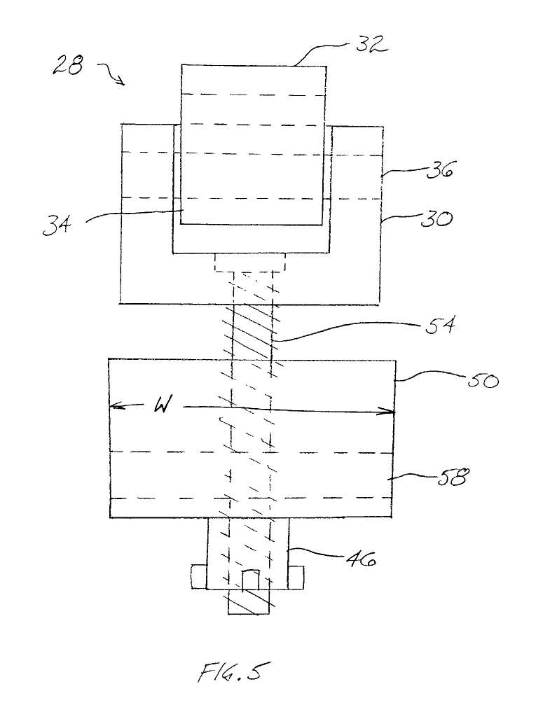

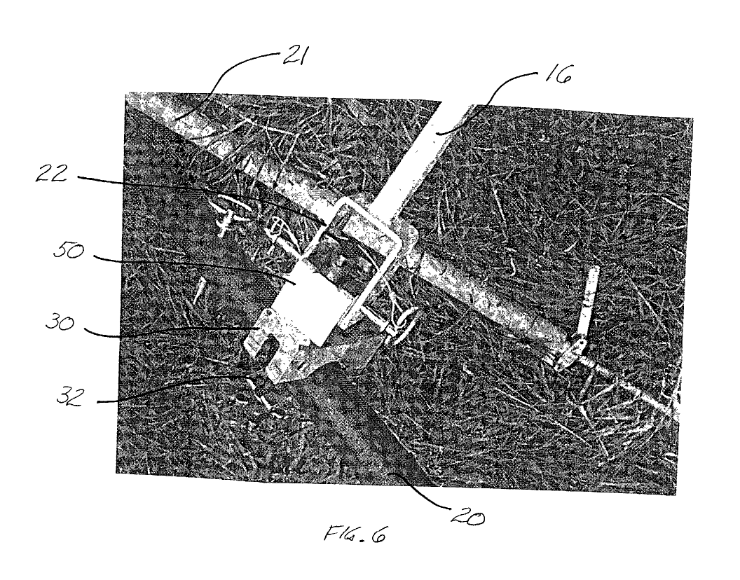

Turning now to FIGS. 4-6, the adaptable securing means includes a clamp 28 to which the bracket 22 of the cross brace 16 connects, and which also turn releasably engages at least one of the members 12, 14, 20 and 21 without a pin. The clamp 28 provides flexibility as to the location and orientation of the connection of the cross braces 16 (FIGS. 1 and 2).

The clamp 28 includes a body 30 that is pivotally connected to a securing member 32. The securing member 32 includes a first end 34, near which is a pin 36 or other similar means known in the art to provide the pivot connection. The securing member 32 also includes a second end 38. To engage one of the members 12,14, 20 and 21, such as an extension member 20, the first end 38 of the securing member 32 is opened, or pivoted away from the body 30, and a recess 39 defined in the body is placed on the desired section of the extension member 20. The securing member 32 is pi voted back to a closed position (shown), thus allowing the clamp 28 to substantially surround the desired section of the extension member 20.

A fastener 40, such as an eye bolt, is pivoted about a bolt pin 42 until the fastener 40 engages a slot (not shown) in the first end 38 of the securing member 32. A nut 44 secures the first end 38 of the securing member 32 to the body 30, thereby fixing the clamp 28 in position on the extension member 20. The nut 44 may include projections 46 to allow it to be tightened and/or loosened easily without additional tools.

The body 30 of the clamp 28 includes a base 48, to which a first selectively pivotable block 50 and a second selectively pivotable block 52 connect. A first fastener 54, such a bolt, connects the first block 50 to the body 30, while a second fastener 56 connects the second block 52 to the body 30. Nuts 46 may be used with the first 54 and second 56 fasteners to secure the blocks 50 and 52 to the body 30. Thus, once the orientation of each block 50 and 52 is selected, the nuts 46 are tightened to secure the blocks 50 and 52 against the body 30, holding the blocks 50 and 52 at the desired orientation.

The first block 50 defines an orifice 58 to receive a pin and the second block 52 also defines an orifice 60 to receive a pin. Each block 50 and 52 is of a width just under a distance W, to slide into the channel 24 of the bracket 22 of the cross brace 16 (FIG. 3). When a block, for example, the first block 50, slides into the channel 24 of the bracket 22 of the cross brace 16, the orifice 58 defined in the block 50 may be aligned with at least two of the orifices 26 in the bracket 22 so that a pin may inserted through the aligned orifices 26 and 58, thereby securing the cross brace 16 to the clamp 28 at the desired orientation. Because the clamp 28 is secured to a member, such as the extension member 20, the cross brace 16 is connected by the clamp 28 to the extension member 20.

It is to be noted that two different cross braces 16 may be used, with each one having a bracket 22 as described. One cross brace may be of a different diameter than the other, to allow the smaller brace to slide inside the other and be adjustably pinned. In this manner, an adjustable bracing assembly including two cross braces 16 may have a bracket 22 at either end.

As a result, the clamp 28 provides an easily installed, adaptable means to secure cross braces 16 to members 12, 14, 20 and 21 and increase the stability of the shoring systems 10 and 18. As is apparent from the foregoing detailed description, a method for using the clamp 28 is also provided. Particular note is made that the clamp 28 may be used in applications other than shoring systems. Reference is made herein to use of the clamp 28 in a shoring system only as an example.

The invention has been described with reference to preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A clamp for securing multiple items, comprising:
a body;
a securing means connected to the body, wherein the securing means and the body cooperate to engage a first item; and
at least one selectively pivotable block connected to the body, wherein the block is connected to a second item to be clamped.

2. The clamp of claim 1, wherein the connection of the securing means to the body includes a pivot connection.

3. The clamp of claim 1, wherein the engagement of the body and the securing means is secured by a nut and a bolt.

4. The clamp of claim 3, wherein the nut includes projections.

5. The clamp of claim 1, wherein the block is affixed to the body at a desired orientation.

6. The clamp of claim 5, wherein the connection of the block to the body includes a nut and bolt.

7. The clamp of claim 1, wherein the block defines an orifice.

8. The clamp of claim 8, wherein the connection of the block to the second item to be clamped includes a pin.

9. The clamp of claim 1, wherein the at least one block includes two blocks.

10. A connecting system for a support member, comprising:
a cross brace including a bracket; and
a clamp, including:
a body;
a securing means connected to the body, wherein the securing means and the body cooperate to engage the support member; and
at least one selectively pivotable block connected to the body, wherein the block is connected to the bracket of the cross brace.

11. The clamp of claim 10, wherein the connection of the securing means to the body includes a pivot connection.

12. The clamp of claim 10, wherein the engagement of the body and the securing means is secured by a nut and a bolt.

13. The clamp of claim 12, wherein the nut includes projections.

14. The clamp of claim 10, wherein the block is affixed to the body at a desired orientation.

15. The clamp of claim 14, wherein the connection of the block to the body includes a nut and bolt.

16. The clamp of claim 10, wherein the block defines an orifice and the bracket of the cross brace defines an orifice.

17. The clamp of claim 16, wherein the connection of the block to the bracket of the cross brace includes a pin that engages the orifices in the block and the bracket.

18. The clamp of claim 10, wherein the at least one block includes two blocks.

19. A method for clamping, comprising the steps of:
providing a first item to be secured;
placing a body of a clamp on a desired location of the first item to be secured;
closing a securing member of the clamp about the item to be secured;
tightening the securing member to the body of the clamp;
providing a second item to be secured;
selecting a desired orientation of a block connected to the body of the clamp;
affixing the block to the body of the clamp at the desired location; and
connecting the block to the second item to be secured.

20. The method for clamping of claim 19, wherein the step of connecting the block to the second item to be secured includes pinning the block to the second item.
